(19) United States
(12) Patent Application Publication
(10) Pub. No.: US 2002/0141584 A1
(43) Pub. Date: Oct. 3, 2002

(54) Clearinghouse for enabling real-time remote digital rights management, copyright protection and distribution auditing

(76) Inventors: Ravi Razdan, (US); Shivani Bommakanty, (US)

Correspondence Address: STREAMTONE, INC, 2683 VIA DE LA VALLE, G-427, DELMAR, CA, 92014, US

(21) Appl. No.: 09/769,443

(22) Filed: Jan. 26, 2001

(51) Int. Cl. H04N 7/167; G06F 17/60

(52) U.S. Cl. 380/203; 705/53

(57) ABSTRACT

A digital-works Clearinghouse comprises a database, which stores meta-information relating to digital-works and a server configured to coordinate digital-works transactions, distribution, auditing, tracking, monitoring, advertisement insertion and collection of meta-data of a digital work such that, a digital-work Publisher can remotely monitor a digital work by communicating with the Clearinghouse server regarding the digital work. Furthermore, the digital-works Clearinghouse comprises a software application that is modular and is given to the digital-works Distributor's such that it is responsible for enabling copyright protection, distribution, distribution auditing and communicating with Clearinghouse and other Distributors whereby a Publisher can remotely monitor their digital work.

### BACKGROUND OF THE INVENTION

1. Field of the Invention

This invention relates to providing web services, specifically auditing, monitoring, securing, distributing and copyright managing services over the Internet for software application services.

2. Related Art

The Internet and the World Wide Web (“Web”) are becoming the ultimate distribution channel for digital works. Due to its role as the ultimate channel of distribution of Digital works, there is a proliferation of Digital-Works Publishers (DWPs) and Digital-Works Distributors (DWDs) on the Internet. Digital works generally encompass all potentially copyrightable subject matter that can be stored in an electronic form and sold via a computer network. Alternatively, Digital-Works may be referred to as Digital Asset or Digital Object. Typically, this electronic form is digital information, and the sale is of use of a copy of the digital information. Thus, digital works include traditionally static information objects, such as texts, images, music, movies, games and computer programs, and dynamic information objects, such as computer program application services and live broadcasts or streams of digital contents or interactive content services.

Many companies have copyrightable subject matter that are currently using the Web as a distribution medium. Much of the copyrightable work is undergoing Digitization. Digitization is the encoding of the underlying copyrightable subject matter into digital format. Some copyrightable subject matter such as software is created in the digital format to begin with. DWP is the owner of the digital work. DWPs generally create, sustain and develop digital works. For example, A Publisher of books, such as Random House and McGraw Hill are involved in the creation of hard copy texts and traditional books and magazines. They are also responsible for authorizing the digitization of the copyrightable work by a third party or may even be involved in the digitization of the work. In this sense they are not only the traditional “Publisher” but also the “Digital Works Publisher.” DWPs may also be a Music Label such as Universal Music Group and BMG. DWP may also be a publisher of software, such as Adobe and Sun Microsystems. DWPs may also be motion picture studios and advertisers with advertising content.

DWP may choose from a multitude of distributors over the Internet to distribute their digital-work to an end consumer. Digital Works Distributor is any entity that is licensed to distribute the digital work in some fashion that is not the owner of the digital work. Such a Digital Works Distributor (DWD) may be a Content Service Provider (CSP) such as www.reuters.com, or www.cnn.com, www.lexisnexis.com that provide digital content to consumers as either a downloaded information object or a streamed information object, according to the terms of their service. These CSPs bill the consumer directly for the delivered digital content, either electronically or through standard mail systems or rely on advertising revenues. Some of these may provide the content at no charge.

Other DWD's may be Application Service Providers (ASPs) such as www.jamcracker.com, which provide application services over the Internet by making software available for use through the Internet, such as Internet-based calendering, emailing and project management services. These ASPs typically charge a monthly subscription fee based on the number of users. Some ASPs do not bill the consumer for the application services, but rely on advertising revenues instead. Other ASP's charge the consumer for the delivered software and application after delivery. Some ASPs deliver the software applications over the Internet for later use by a consumer or require the user to login to the Web site in order to use the application services. These ASPs may rely on the sale of marketing data they collect from consumers to generate revenue.

Other DWD's may be Internet Service Providers (ISPs) such as www.aol.com, and www.roadrunner.com or Internet Portals such as www.yahoo.com, www.altavista.com and e-tailers such as www.amazon.com and www.barnesandnoble.com. Alternatively, DWD's may be referred to as Content Delivery Networks and Internet Service Vendors such as Akamai, IBEAM or Digital Island. All these entities are involved in the distribution of the digital work to a consumer or another distributor. Each DWD has a dedicated consumer base, end user or businesses and has invested a considerable amount of resources to develop such a consumer base, end user or business. Such DWDs will not want to jeopardize losing a dedicated audience to another distributor. Some DWD's develop a niche audience. For example, there might be a DWD who specializes in distributing Latin Music and has a dedicated consumer base of Latin Music aficionados. If one of their Consumer's wants an e-book by a Latin American Author, he or she may have to go to a Distributor who specializes in such digital works. Some DWD's prevent a Consumer from leaving their web site of another DWD or prevent DWD to siphon off their Consumer by integrating several different or related services on to their site. They may decide to provide all types of services related to a Latin Consumer base on their web-site. However, this is only a temporary solution. DWD's ideally would like to maintain and expand their consumer base while at the same time fulfilling consumer needs. This ensures that their consumers will not have the need to go to another distributor.

Currently, if a DWP or traditional clearinghouse agency such as the United States Copyright Office or Association of Composers, Authors and Publishers (ASCAP) wants information on how much content was actually delivered to a consumer, they have to rely on the auditing information that the Distributor provides to it. Thus, DWPs have to go to various Distributors to receive auditing data on how and where their digital assets were purchased and or used. Each Distributor may have a unique method of collecting such information. Some Distributors may not have a mechanism for recording such information. Therefore, DWPs have no control of how and where their digital assets are distributed. DWPs have no accurate, reliable, uniform and instant source of determining how and where their digital assets have been delivered.

Traditional methods of gathering information on sales and distribution of digital works includes tracking bar codes attached to each piece of digital work sold. Each piece of digital work that is sold may have a bar code, which is scanned by the retailer at time of the transaction. Bar code encompasses the identifying information of a piece of digital work. At the end of given period of time, the bar code information is gathered and analyzed. DWPs have to rely on the information provided by the distributors to assess the value of a particular digital work. Other methods of gathering information is based on statistical analysis and sampling data. Billboard Music, for example, compiles from a national sample of retail store, mass merchant, and Internet sales reports collected, compiled, and provided by another agency, SoundScan.

DWP does not have a uniform, reliable, instant access to information regarding the status of a given digital asset once it is released onto the Web. Therefore, it is necessary to provide a mechanism by which a DWP or other authorized agency interested in such information can remotely monitor, account, securely distribute, protect and transfer their digital asset over the Web. A method of enabling digital rights management, copyright protection and distribution via a neutral third party is needed to give DWPs more control over their digital assets along with more precise, accurate, credible and instantaneous information regarding the distribution of their assets. This will ensure that the DWP's allocate and account for the development of their digital assets in a more reliable and resourceful fashion and conduct more targeted marketing to enhance their revenue streams.

### SUMMARY OF THE INVENTION

This invention can be regarded as a method of enabling remote digital rights management, copyright protection and distribution of digital works, both digital content downloads, broadcasts and application services, owned by digital works publishers. The method includes the step of providing a digital-rights clearinghouse attached to a computer network along with application software that is provided and resides on distributor's server. The digital-works clearinghouse is designed to coordinate sales and deliveries and monitor, securitize, transfer and collect meta-data of digital works by authorized digital works distributors, whereby distributor bills a customer for a digital work delivered electronically to the customer by a digital works distributor and Publisher obtains tracking and auditing information of a digital work.

This invention can also be regarded as a method of monitoring electronic sales of digital works and licenses to use digital works. The method includes the steps of providing application software by a distributor from clearinghouse on to distributor's server. This application software will capture Meta-data regarding the digital works available on distributor's server and monitor and track the digital work's activities. The Meta-data captured from various distributors will reside on a database at the Clearinghouse. The method further includes the steps of providing an audit trail of the digital work from creation to delivery to a customer access device, or transfer of digital work to another authorized distributor through the use of watermarks.

In this fashion, the present invention enables a digital-works clearinghouse to seamlessly monitor digital-works.

This invention can also be regarded as a method of streaming digital works owned by DWP. The method includes the step of providing a DWD, application software that will keep a record of the content identity and the content location of the content that was streamed. When a request for streaming of content is made, the application will electronically link to where the content resides and stream the content. The method further includes the step of inserting a watermark in intervals of the stream so that an illegal reproduction of the stream can be traced. The watermark insertion during a stream will also provide a method of tracing and monitoring usage of a stream of digital work.

The invention can also be regarded as a method of watermarking a digital work owned by a DWP. The method includes the step of providing a service that will insert watermarks in a digital work whenever the digital work is transferred or delivered from one Distributor to another either as a download or as a stream.

The invention can also be regarded as a method of encrypting the digital work owned by a DWP. The method includes the step of providing an application software that resides on Distributor's server. The application will encrypt a digital work before transfer and delivery of the work to a consumer. The encryption application will encrypt the passed static content or stream blocks.

The invention can also be regarded as a method of logging all activity of the digital work. The downloaded software application that resides on the Distributor's server will have a logging mechanism whereby, when the digital work is streamed, the logger will log the information regarding the time of stream, the location of the stream, the content identity of the stream. The logging mechanism includes the step of communicating with the Clearinghouse at a designated time and passing the logged information to a central database in the Clearinghouse where information regarding the activity pursued by a digital work residing with one or many Distributors is stored. The invention can also be regarded as a method of accounting and auditing all the transactions processed by a Distributor. The method includes the step of downloading a software application that resides in the Distributor's server that will process and prepare in a concise and manageable fashion all the logged activity of the digital works present in the Distributor's site.

Thus, the present invention provides digital-works Publishers the ability to easily monitor their digital works thereby having more control of how their digital works are used and at the same time allowing the Distributor to maintain and expand their customer base. The Clearinghouse will track the activity of the digital work at various Distributor sites and relay the information to the Publisher or other authorized interested party. The Clearinghouse and application software connected to it from a DWD will provide a mechanism by which the digital work and copyrights of the owner of the digital work are protected through encryption and watermarking.

This invention can also be regarded as a computer-implemented digital-works distribution system The downloaded software application will also have the capacity to securely transfer a digital work from one Distributor to another or Clearinghouse to Distributor. This capability is especially useful to a Distributor because it allows the Distributor to provide its consumer a digital work that does not reside on its server. The application software will communicate with the Clearinghouse to determine where the digital work resides and will provide a secure mechanism by which to transfer the digital work from one Distributor to another or get meta-data regarding digital work so that it can connect to the Distributor itself.

In one embodiment, the digital-works application provides a mechanism by which Distributor can insert an advertisement in between streams or downloads. The application will communicate with the streaming module to coordinate insertion of an advertisement in between streams or downloads of a digital work. Thus a DWD and Publisher can gain advertising revenues along with protecting and accounting for their digital assets. In this embodiment, the clearinghouse enables real-time advertisement time slot arbitrage so that distributors and advertisers can simultaneously buy and sell advertisement time slots so that an advertiser can insert advertisements between streams of a digital work or otherwise.

By creating a monitoring, managing, auditing, tracking, securing, distributing mechanism of digital works, the present invention provides accurate, precise, instantaneous information by a neutral third party on where and how digital works are used and distributed. It also enables a method of protecting copyrights through watermarking and encryption. This mechanism also allows various Distributors to maintain their customer base by providing the customers what they require without having to navigate to another Distributor's customer interface. Thus this method enables the remote real-time digital rights management, copyright protection and distribution.

Further features and advantages of the invention as well as the structure and operation of various embodiments of the invention are described in detail below with reference to the accompanying drawings.

### BRIEF DESCRIPTION OF THE FIGURES

FIG. 1 is a block diagram illustrating a digital-works Clearinghouse system in an example operational environment according to one embodiment of the invention;

FIG. 2 is a block diagram illustrating primary components of a digital-works application downloaded by Distributors onto their servers according to one embodiment of the invention;

FIG. 3 is a block diagram illustrating primary components of a digital-works Clearinghouse system according to one embodiment of the invention;

FIG. 4 is a block diagram illustrating event sequence and message flow between a digital-works Clearinghouse system and Distributor system and Publisher system according to one embodiment of the invention;

FIG. 5 is a block diagram illustrating event sequence and message flow in a digital-works Clearinghouse system and multiple Distributor systems according to one embodiment of the invention;

FIG. 6 is a block diagram illustrating event sequence and message flow in a digital works Clearinghouse system and Distributor system according to one embodiment of the invention;

FIG. 7 is a block diagram illustrating event sequence and message flow between Distributor system, Clearinghouse system and advertiser system according to one embodiment of the invention

FIG. 8 is a flow chart illustrating how a digital work is watermarked, encrypted, transferred and logged according to one embodiment of the invention.

FIG. 9 is a flow chart illustrating how Clearinghouse queries the Distributor and relays the auditing information to the Publisher according to one embodiment of the invention.

FIG. 10 is a flow chart illustrating how a Distributor queries the Clearinghouse to get information on where a digital work resides that is unavailable on its servers according to one embodiment of the invention.

FIG. 11 is a flow chart illustrating how the application alerts the Clearinghouse of the availability of a new work according to one embodiment of the invention.

FIG. 12 is a flow chart illustrating how the Clearinghouse coordinates the insertion of an advertisement according to one embodiment of the invention.

FIG. 13 is a sample web page illustrating how a Publisher or advertiser will login to the Clearinghouse.

FIG. 14 is a sample web page illustrating how auditing information will be displayed once a Publisher has logged into the Clearinghouse.

### DETAILED DESCRIPTION OF THE INVENTION

The present invention is directed toward a system and method for enabling a DWP or other authorized agency to remotely monitor, audit, account, track, and protect digital works once the digital work is released to a Distributor and to allow transfer and distribution of digital work from one Distributor to another and from Distributor to an end consumer. The present invention is disclosed and described herein in terms of Web sites running on dedicated servers utilizing the Internet and the World Wide Web. However, after reading this description, it will become apparent to one of ordinary skill in the art how to implement the invention in alternative embodiments and alternative network environments.

For example, alternative embodiments include multiple servers for each Web site, or user interfaces that use hyper linking protocols other than the Hypertext Transfer Protocol (“HTTP”). Alternative network environments include any “Future Net” and its accompanying networking protocols, which will likely encompass the functions now provided by today's Internet, cable and broadcast television, telephone communications and other linear and interactive business and telecommunications systems. As such, the description of this example embodiment should not be construed to limit the scope and breadth of the present invention.

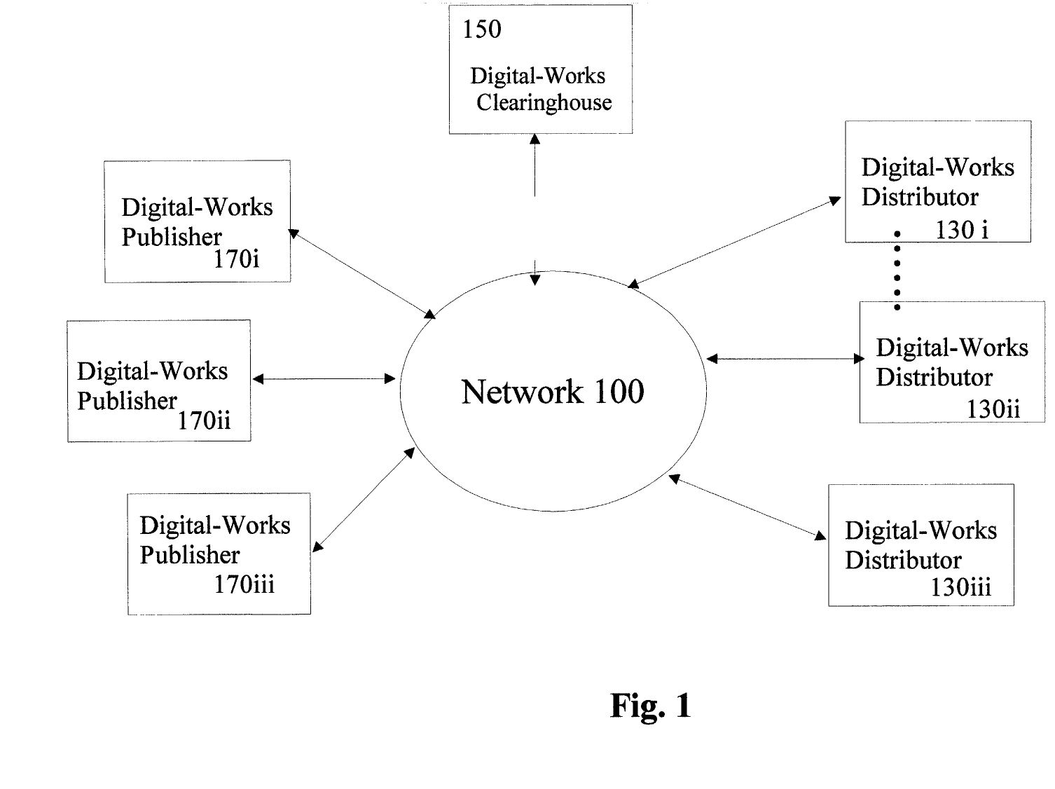

FIG. 1 is a block diagram illustrating a digital-works Clearinghouse system in an example operational environment according to one embodiment of the invention. A network 100 is a computer network such as the Internet, which allows multiple devices to be communicatively coupled together. In this example embodiment, the network 100 utilizes the Internet Protocol (“IP”) to enable this communicative coupling, and the network 100 includes both wire/fiber and wireless network components.

Coupled with the network 100 are digital-works Distributors 130. In one embodiment, the digital-works Distributors 130 are Web sites running on dedicated servers. These Web sites include digital-works encoding, sales, storage and distribution systems. Examples of Web server software that can be used to construct such systems include Apache, Microsoft Internet Information Server, Netscape Enterprise Server, ATG dynamo, Web Logic and Web Sphere. The Web server software can be designed to run on any number of computer hardware platforms with any number of operating systems and utilizing any number of programming languages for implementing scripts.

A digital-works Clearinghouse 150 is also coupled with the network 100. In one embodiment, the digital-works Clearinghouse 150 is a centralized Web server for coordinating digital-works distributions utilizing real-time encryption and watermarking and monitoring of downloads, streams and copyright protection through digital watermarks. The digital-works Clearinghouse 150 includes storage facilities for meta-data that identifies providers for multiple types of digital works, such as digital content like music, movies, images, video, electronic books, audio books, magazines, advertisements, broadcast or streaming services and application services like tax preparation software, financial planing software, calendaring services, e-mail services, and entertainment services. Note that the digital works are not limited to the ones enumerated herein. In one embodiment, the digital works comprising digital content are available in industry promulgated file formats.

Although the invention is disclosed herein in terms of a single centralized digital-works Clearinghouse 150 with its own local storage, those skilled in the relevant art(s) will understand that the present invention encompasses multiple alternative architectures. For example, the functionality described herein can be distributed over a plurality of computers.

In one embodiment, the digital-works Clearinghouse 150 is configured in a distributed architecture, wherein databases and processors within the digital-works Clearinghouse 150 are housed in separate units or locations. Some units perform the primary processing functions and contain, at a minimum, memory and a general processor. Each of these units is attached to a wide area network (“WAN”) hub which serves as the primary communications link with the other units and interface devices. The WAN hub may have minimal processing capability itself, serving primarily as a communications router. Those skilled in the relevant art(s) will appreciate that an almost unlimited number of servers may be supported. This arrangement yields a more dynamic and flexible system, less prone to catastrophic hardware failures affecting the entire system.

In an alternative embodiment, the digital-works Clearinghouse 150 is configured in a distributed fashion, such that a separate digital-works Clearinghouse is located in each geographical region and maintains communications with all other digital-works Clearinghouses. In this embodiment, all the separate digital-works Clearinghouses taken together form a single Web site residing in multiple geographically diverse data centers.

Also coupled with the network 100 are digital-works Publishers 170. In one embodiment, the digital-works Publishers 170 are Web sites running on dedicated servers. These Web sites include digital-works sales and distribution systems, which have their own digital works for sale through the system. Thus, the digital-works Publishers 170 can also be regarded as DWD's.

Both the digital-works Publisher 170 and the digital-works Distributor 130 may be designed using multiple alternative architectures as discussed previously in connection with the digital-works Clearinghouse 150. Moreover, as discussed in greater detail below, the present invention enables any number of Distributors to utilize the Clearinghouse to purchase digital works from any number of digital-works Distributors, without a customer ever leaving a preferred user presentation created and displayed by the digital-works Distributor. Note that in one Web-based embodiment, all communications utilize the Secure Sockets Layer (“SSL”) for communication security.

In an alternative embodiment, a second network (not shown) is used to provide highly secure communications. For example, in one embodiment, the second network is a proprietary network connecting the digital-works Publishers 170 communicates with the digital-works Clearinghouse 150. In this embodiment, the digital-works Publisher 170 communicates with the digital-works Clearinghouse 150.

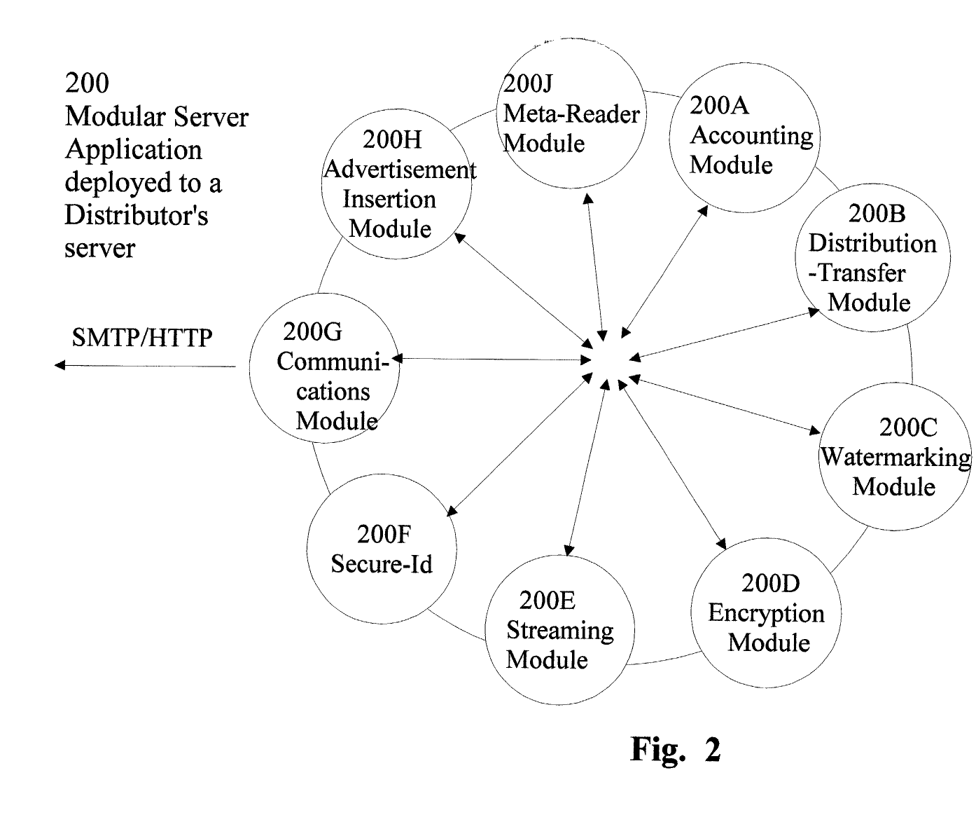

FIG. 2 is a diagram of the software application that a Distributor will download from the Clearinghouse website. In one embodiment, the application will be downloaded from Clearinghouse website. However in an alternative embodiment, the Distributor may receive the application on a Compact Disc. In yet another embodiment, the Distributor may receive application pre-installed on a server. In the preferred embodiment, the application is modular and deployed on to an apache server. Modular application may be written in any programming language such as C programming language or scripting language such as Perl. Modular programming is the concept that similar functions should be contained within the same unit of programming code and that separate functions should be developed as separate units of code so that the code can easily be maintained and reused by different programs. In an example embodiment each module serves a unique purpose. The application thus allows for functionality and flexibility. The entire application may be deployed onto a Distributor's server or server farms. Also, different modules may be deployed to different servers in a server farm. The application is based on hierarchical clustering and is designed to be separately and loosely coupled. Therefore, a Distributor may only request a few modules and these modules may be deployed to different parts of a server or may reside together. In another example embodiment, the module may be “Thin” that is it is only required to do one thing well without needing to provide any other service and with a very limited storage capability. In an example embodiment, module may serve more than one specific function, it may serve two or more related functions. In yet another embodiment the module may be highly specialized. The application also communicates and logs onto servers other than the host server, such as Clearinghouse server and other Distributor servers. The application is communicatively coupled to its host server and the Clearinghouse server. In one embodiment, the entire application communicates using Secure Mail Transfer Protocol/Hypertext Transfer Protocol (SMTP/HTTP) or Java Message Service. In one embodiment, the modules in the application communicate with each other using HTTP, TCP/IP sockets or equivalent technology.

In an example embodiment, module A is an auditing module that will process all redundant data and present information logged in a concise and manageable fashion. In one embodiment, module A may be a program that organizes and prepares redundant data into a concise format. In an alternative embodiment, module A may connect to a database system that organizes and prepares the data.

Module B is a distribution and transfer module. It is responsible for connecting to different Distributor's servers or Clearinghouse server to transfer digital works to fulfill a customer request.

Module C is a watermarking module responsible for watermarking passed static content or a dynamic stream blocks. In one embodiment, these watermarking services enable real-time watermarking of a digital work being delivered to a customer such that the watermark(s) identifies an association between the Distributor, the customer, the retailer, the Clearinghouse or some combination of these, for that transaction, thereby enabling trace-ability. The watermark module G puts a digital watermark in requested digital works to identify any future copyright violations. The watermark(s) can be a character string indicating such an association or a numerical identifier that references such an association stored by the Clearinghouse, the provider, the retailer or some combination of these. The watermarking module receives meta-data regarding proper portions of the digital work to insert watermarks from the Meta-data Database residing at the Clearinghouse.

Module D is the encryption module responsible for encrypting the passed static content or stream blocks. The encryption module D provides encryption services to the server it is attached to. It receives the encryption key from the Meta-data database residing at the Clearinghouse. In one embodiment, these encryption services enable real-time encryption of a digital work being delivered to a Distributor or consumer such that only that Distributor or consumer can decrypt the digital work. The encryption module D encrypts the digital work before delivery to the end customer to prevent unauthorized use.

Module E is the streaming module responsible for tracking streams and downloads and also streaming a digital work.

Module F is secure-id module that handles security for the whole module using a digital certificate and symmetric key embedded in the module.

Module G is a communications module responsible for communicating with the Clearinghouse server and other modules. In one embodiment, the communication module moves communications between the modules and manages the processes to provide load balancing.

Module H is an advertisement insertion module that is capable of interacting with the streaming module G to insert advertisements in between streams.

Module J is a Meta-Data Reader module that is responsible for reading and capturing meta-data of a digital work once it becomes available. In an alternative embodiment, a Meta-Data Reader may be used so that any pieces of content introduced in storage area managed by Meta-Data Reader allows the Meta-Data Reader to discover the meta-data associated with that digital work. The Meta-Data Reader then captures this information for each piece of content introduced in the environment. When the communications node on the communication module connects to the Clearinghouse it relays this information to the central meta-data database in the Clearinghouse. The discovery process may be done by periodically reading the file headers. In another embodiment, meta-data may be discovered by registering a directory accessed by the module. For example, by using Lightweight Directory Access Protocol (LDAP) whereby the communication module calls the Clearinghouse to register the digital work as soon as the digital work becomes available and the meta-data is captured.

In the preceding example, note that the modules are not limited to the specific order stated herein. Also, the modules are not limited in number. Therefore, in an alternative embodiment the invention may only contain four modules. For example only the Managing module J, Watermarking module C, Encryption module and Streaming module E. In another example embodiment, the modules may be more than the ones enumerated herein. In another example embodiment, the application may only have one module. In another example embodiment, the module may be “thin” that is it is only required to do one thing well without needing to provide any other service and with a very limited storage capability. In an example embodiment, module may serve more than one specific function, it may serve two or more related functions. In yet another embodiment the module may be highly specialized. Thus the modules are designed so that they are hierarchically clustered and separately and loosely coupled.

The present invention, hereby discloses a modular software application that is either downloaded or delivered through other means and has various modules that serve different functions and interact with each other and the environment to enable digital rights management.

In an example embodiment, the various modules communicate with each other through socket technology. Sockets is a method for communication between processes. Sockets are created and used with a set of programming requests or “function calls” sometimes called the sockets application programming interface (application program interface). In an example embodiment, there is a process such as a daemon that waits in a port on a server and “listens to” communications. A daemon is a program that runs continuously and exists for the purpose of handling periodic service requests that a computer system expects to receive. The daemon program forwards the requests to other programs (or processes) as appropriate. Each server of pages on the Web has an HTTPD or Hypertext Transfer Protocol daemon that continually waits for requests to come in from Web clients and their users. On a Web server or HTTPd (Hypertext Transport Protocol daemon), port 80 is the port that the server “listens to” or expects to receive from a Web client.

In one embodiment, the communications module is responsible for handling all communication with the application. The communication module will respond to queries from the Clearinghouse and relay information back to the Clearinghouse. In an example embodiment the communications may be in SMTP/HTTP of Java Messaging Service.

In another embodiment, the application may contain only one module. For example, the application may only have the encryption module D that provides encryption services to the server it is attached to. In one embodiment, these encryption services enable real-time encryption of a digital work being delivered to a Distributor or consumer such that only that Distributor or consumer can decrypt the digital work. The encryption module D encrypts the digital work before delivery to the end customer to prevent unauthorized use.

In another embodiment, the application may only contain the watermarking module C that provides watermarking services to the Web server it is attached to. In one embodiment, these watermarking services enable real-time watermarking of a digital work being delivered to a customer such that the watermark(s) identifies an association between the Distributor, the customer, the retailer, the Clearinghouse or some combination of these, for that transaction, thereby enabling trace-ability. The watermark module G puts a digital watermark in requested digital works to identify any future copyright violations. The watermark(s) can be a character string indicating such an association or a numerical identifier that references such an association stored by the Clearinghouse, the provider, the retailer or some combination of these.

In the preceding two example embodiments, the invention allows a Distributor to select the module that it requires with out receiving the entire application with all the modules. Thus, the present invention enables flexibility so that a Distributor can contract for services it truly needs. Therefore a Distributor that only needs watermarking services will download or receive the watermarking module G or both watermarking module G and encryption module D.

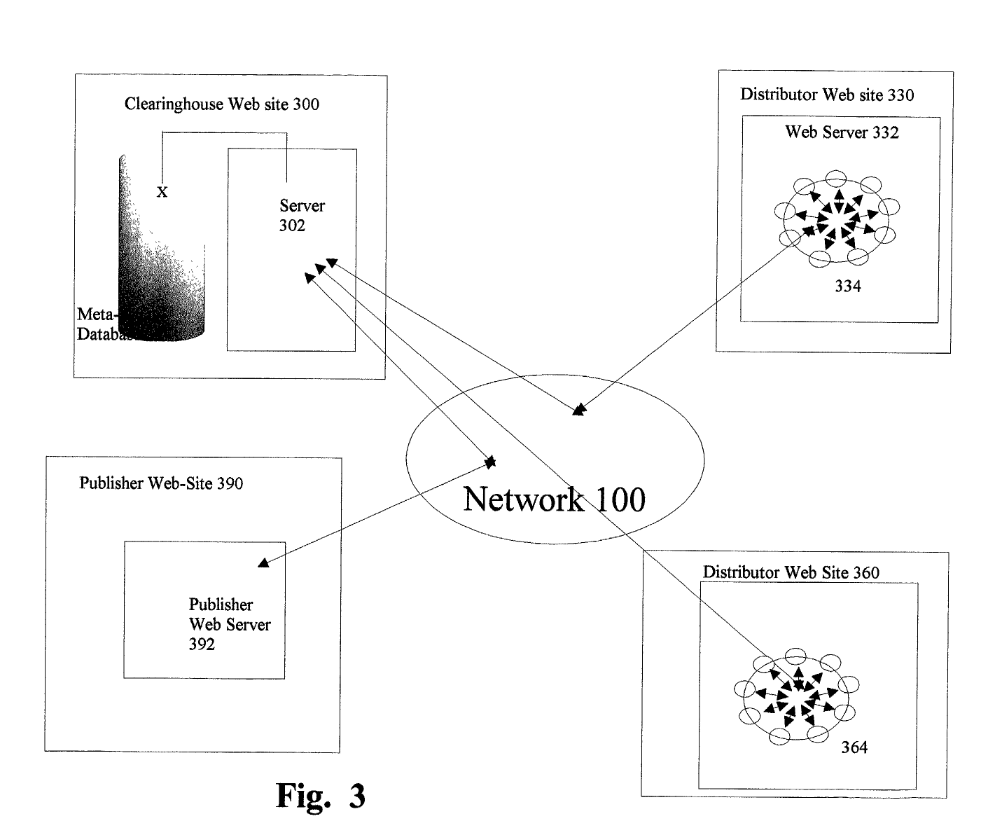

FIG. 3. is block diagram illustrating primary components of a digital-works Clearinghouse system according to one embodiment of the invention. Referring now to FIG. 3, the network 100 is the same as that shown in FIG. 1. Generally, unless otherwise indicated, like numerals refer to like elements throughout this specification.

Although the invention is disclosed herein in terms of HTTP for communications and XML for data exchange, the present invention fully contemplates the use of other high-level protocols residing over TCP/IP such as WAP (Wireless Application Protocol), and variants of HTTP such as HTTPS (Hypertext Transfer Protocol Secure) and HTTP-NG (Hypertext Transfer Protocol-Next Generation), and alternative hypertext markup languages such as WML (Wireless Mark-up Language). Moreover, the present invention fully contemplates the use of other networking protocols, both high-level and low-level, including those not yet developed.

Coupled with the network 100 is an example Distributor Web site 330. The Distributor Web site 330 distributes/sells digital works to consumers using a digital-works sales, transfer and billing system. The Distributor Web site 330 may or may not sell its own digital works. In this example embodiment, the Distributor web site 330 only sells the digital works of DWPs.

The Distributor Web site 330 comprises a Web server 332, and a downloaded modular application 334 (the same modular application described in FIG. 2) that is deployed to the web server. As discussed previously, the Web server 332 can be built using any number of computer hardware platforms running standard Web server software, such as Apache, Microsoft Internet Information Server, ATG dynamo, Web sphere and Web Logic and Netscape Enterprise Server. The Web server 332 may be customized using computer programs to create the digital-works sales and billing system. These computer programs enable dynamic creation of XML/HTML documents.

The Web server 332 is communicatively coupled with Clearinghouse Web site 300, via the network 100. The Web server 302 responds to customer requests from the customer access devices and also interfaces with the Clearinghouse Web site 300. The Web server 332 is communicatively coupled to the downloaded software application 334. Each module specializing in a specific function captures data from web server 332. The communications module in the application is communicatively coupled to server it resides in and also to the Clearinghouse server 302.

The Clearinghouse Web site 300 is an example implementation of the digital-works Clearinghouse 150. The Clearinghouse Web site 300 comprises a Web server 302, a digital-works meta-data database 304. As discussed previously, the Web server 302 can be built using any number of computer hardware platforms running standard Web server software, such as Apache, on generally available operating systems, such as Linux. The Web server 302 is customized using computer programs to implement the functionality described herein. In one embodiment, these computer programs are implemented using XML for dynamic behavior.

The Web server 302 is communicatively coupled to the Distributor Web site 330, and a Publisher Web site 390, via the network 100. The Web server 302 responds to requests from the Distributor Web site 330 and also interfaces with the Publisher Web site 390. The Web server 302 communicates with the communications module G (FIG. 2) of the modular application 334 to gather data regarding transaction activity of the Distributor's web site.

The digital-works Meta-data Database 304 contains meta-data regarding digital works offered by various Publishers and Distributors. The Meta-data Database relays meta-data to various distributors to enable digital works transfers, watermarking and encryption. Meta-data encompasses data regarding a particular digital work, it may be descriptive meta-data such as the title of the digital work, release date, copyright information such as the author of digital work. Essentially, it is data that stores administrative information. It may also be technical meta-data such as how and when and by whom a particular set of data was collected, and how the data is formatted or the mathematical analysis of a particular digital-work. Meta-data is essential for understanding information stored in data warehouses. An example Meta-data may be the IdV3 Tags of an MP3 file. Although the meta-data database 304 is shown and described in terms of one database, those skilled in the relevant art(s) understand that multiple organizational structures are available for these databases. Additionally, in one embodiment, database software such as Oracle8i, manufactured by Oracle Corporation, is used to create and manage these databases.

The digital-works Meta-Data database 304 contains meta-data of digital works, and in one embodiment, nodes automatically update the database to include new digital works that have been encoded and become available on a Distributor site. In an alternative embodiment, a Meta-Data Reader may be used so that any pieces of content introduced in storage area managed by Meta-Data Reader allows the Meta-Data Reader to discover the meta-data associated with that digital work. The Meta-Data Reader then captures this information for each piece of content introduced in the environment. When the communications node on the communication module connects to the Clearinghouse it relays this information to the central meta-data database in the Clearinghouse. The discovery process may be done by periodically reading the file headers. In another embodiment, meta-data may be discovered by registering a directory accessed by the module. For example, by using Lightweight Directory Access Protocol (LDAP) whereby the communication module calls the Clearinghouse to register the digital work. Although the Clearinghouse Web site 300 is shown and described in terms of one database, those skilled in the relevant art(s) understand that multiple organizational structures are available for these databases. Additionally, in one embodiment, database software such as Oracle8i manufactured by Oracle Corporation, is used to create and manage these databases.

Also coupled with the network 100 is the Publisher Web site 390. The Publisher Web site 390 is the owner of the digital works, and comprises a Web server 392 and databases. As discussed previously, the Web server 392 can be built using any number of computer hardware platforms running standard Web server software, such as Apache, on generally available operating systems, such as Linux. The Web server 392 is customized using computer programs to implement the functionality described herein. In one embodiment, these computer programs are implemented using XML for dynamic behavior.

The Web server 392 is communicatively coupled with the Clearinghouse Web site 300, via the network 100. The Web server 392 communicates with the web server 302 from the Clearinghouse Web site 300.

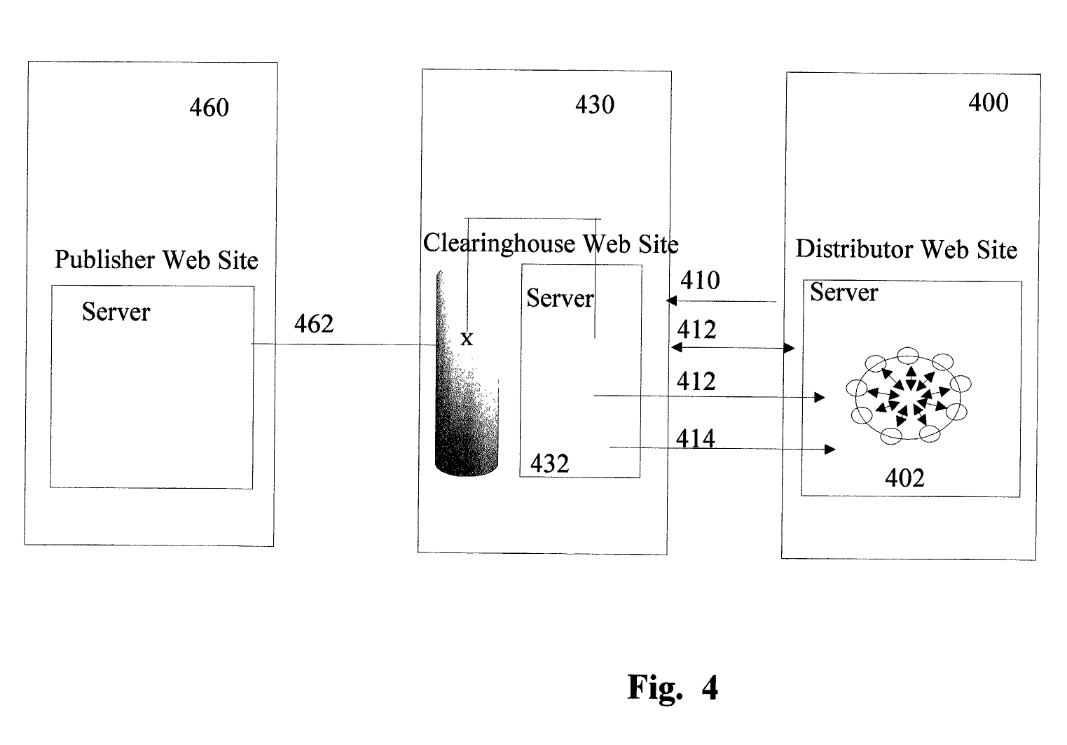

FIG. 4 is a block diagram illustrating event sequence and message flow in a digital-works Clearinghouse system according to one embodiment of the invention. In this embodiment, communication between the different parts of the digital-works Clearinghouse system takes place using HTTP (or its variant protocols such as HTTPS and HTTP-NG) and XML/HTML. Alternatively, other communication protocols may be used. The sequencing of this message flow through the digital-works Clearinghouse system is essentially a transaction protocol that delineates the information that must be provided between the digital-works retailer and the digital-works provider.

In one embodiment, this transaction protocol is an XML based specification that controls how the various Web servers in the digital-works Clearinghouse system communicate with each other. Preferably, all transaction mechanism communications will be secured by some method, such as encryption, use of a proprietary network, use of SSL or user digital certificates. But in some embodiments, only certain of these communications will be secured, depending on the nature of the channel used. For example, if the channel has limited bandwidth, or excessive congestion, only those communications containing security information, which if discovered could leave the system open to infiltration, are encrypted. This is done to improve the performance of the system.

Referring now to FIG. 4, in order for Distributor to install modular application 490, Distributor first logs onto a secure Web site 430 on the Clearinghouse system. This is done by taking an action that causes a login HTTP POST request message 410 to be sent by the Distributor Web site 400. This action can include things such as submitting an XML/HTML form, and clicking a hyperlink on Distributor Web site 430.

In response to login HTTP POST request message 410, the Clearinghouse Web site 430 will send a Web page HTTP response message 412, which contains an XML/HTML document in the entity body field. This XML/HTML document contains a XML/HTML form which requests Distributor to input registration information. Registration information will contain a Distributor-Clearinghouse identifier and a password. The XML/HTML document message 412 will also contain a control-input that enables the Distributor to generate request for the modular application. The XML/HTML document may also contain a control-input that enables the Distributor to provide company details such as the company profile, what service industry they are in, if they would like to provide availability of time slots for promotional and advertisement purposes. The XML/HTML document may also contain a control-input that enables the Distributor may also request customized applications. Alternatively, the control-input could be a submit button on an XML/HTML form, which allows the Distributor to download the modular software application. Once the Modular application 490 is downloaded or otherwise delivered, it will be deployed on to the Distributor's server or server farms.

Once the modular software application is deployed to the Distributor's web server, the Clearinghouse web server may initiate a HTTP POST message 414 to login to the Distributor server module application to request information on transactional activity logged and stored in the logging module and accounting module on the modular software application. The application may deliver the reports created by the accounting module as HTTP GET message. The server-to-server communication can be in the form of HTTP/SMTP mail message file transfer or via Java Message Service (JMS).

Similarly, Publisher's webserver will communicate with Clearinghouse web server to collect tracking information. Clearinghouse web server will send a HTTP POST message 410 to Publisher to relay the transaction information, and other tracking information it has collected during the course of the day or a given time period that is agreed to by the Publisher and Clearinghouse. Publisher may send HTTP POST message 462 on its own initiative to request transactional, tracking and auditing information from the Clearinghouse. This communication can be in the form of HTTP/SMTP mail message file transfer or via Java Message Service. Alternatively, Publisher may log on to a secure web site using login functionality on the Clearinghouse web server to check the tracking information collected and displayed as web page.

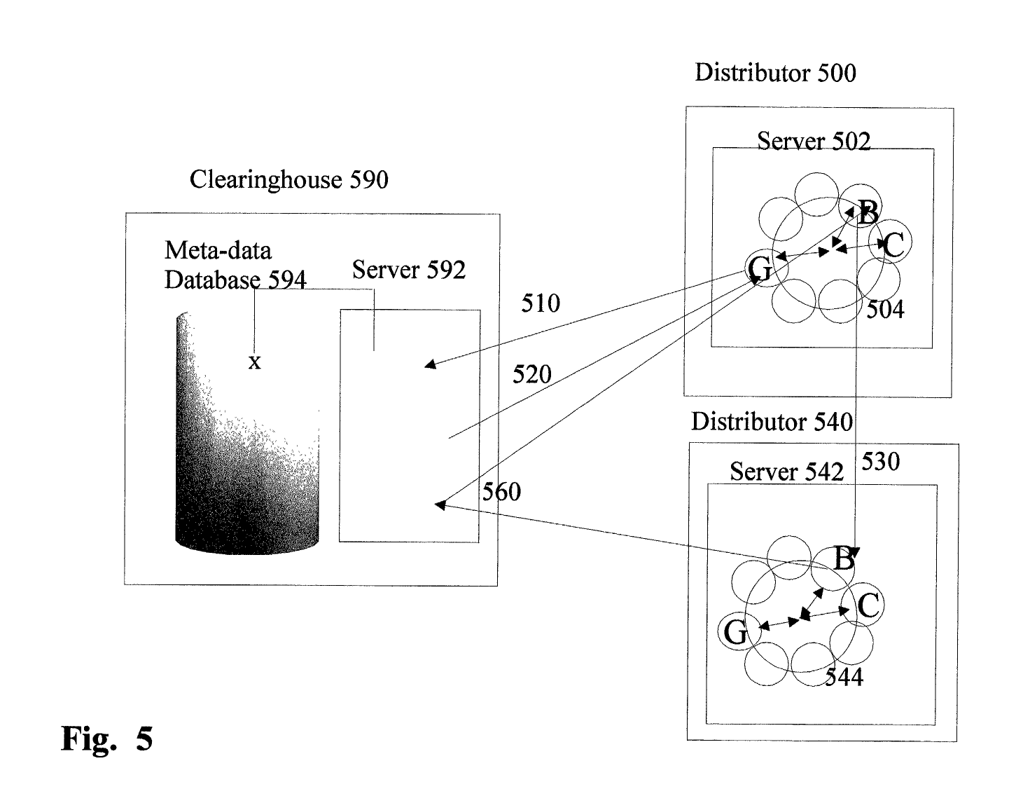

FIG. 5 is a block diagram of sample communication and distribution of a digital work between a Distributor 500 and Clearinghouse 590 and another Distributor 540. Distributor Server 502 upon realizing that a particular digital work is not available on its site will communicate with the communication module 504 (G) to find the digital work for its customer. The communications module 504 (G) will then send communication 510 to the Clearinghouse server 592. The Clearinghouse server 592 will search its Digital Works Meta-Data Database 594 to determine where the digital work is available. It will pass on the information regarding the location of the digital work as message 520 back to the Communication Module 502(G). The message may be in the form of an SMTP/UTTP message or JMS communication. Upon receiving information of where the digital work is available the Distributor 500 will directly connect to the Distributor 560 as depicted by connection 530 and transfer the digital work. Upon transfer of the digital work, the Watermarking module 504(C) of the modular software application 504 residing on Distributor 500's server will insert a watermark identifying the association between the two Distributors. The distribution module 502(B) will store the location of the digital work in its memory so that the next time Distributor 500 is requested the same digital work it will extract the information from its cache memory. The server-to-server communication can be in the form of HTTP/SMTP mail message file transfer or via Java Message Service (JMS). Alternatively, Clearinghouse 590 may transfer the digital work from Distributor 540 to Distributor 500 by connecting to Distributor 540 and then connecting to Distributor 500. This connection is illustrated as connection 560.

In another example embodiment, the DWD seeking a digital work may request the Clearinghouse to transfer the digital work from another Distributor. In this example embodiment, the Clearinghouse will search the meta-data database for the location of the digital work. After determining where the digital work is available, the Clearinghouse will log on to the Distributor with the available digital work and transfer the digital work to the Distributor seeking the digital work. In this example embodiment, the Clearinghouse is transferring the digital work from one Distributor to another.

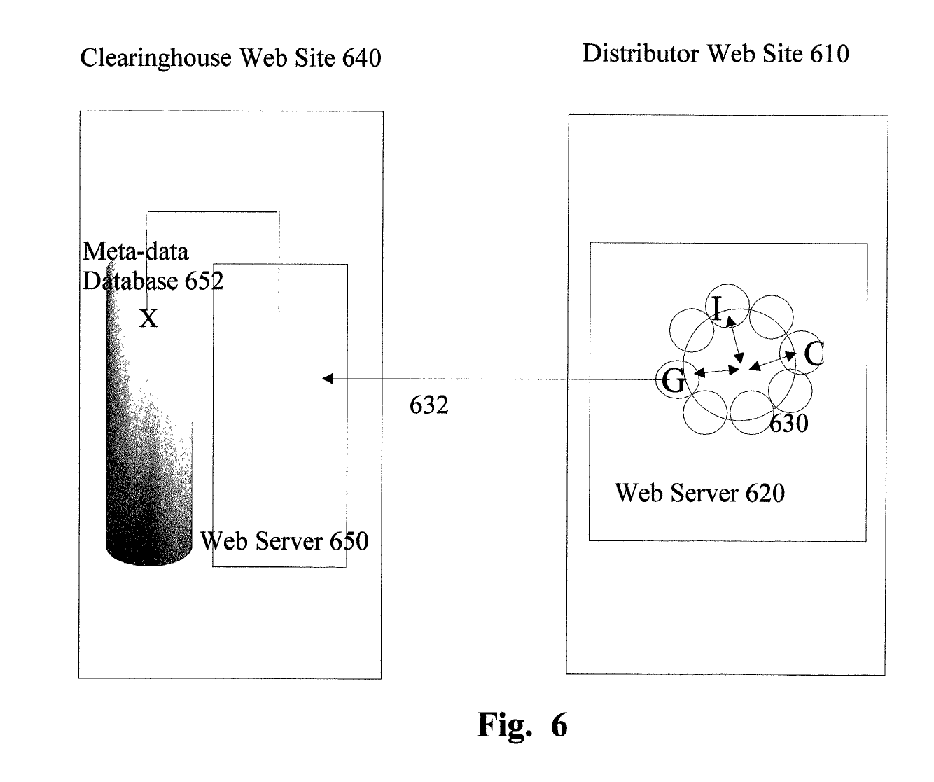

FIG. 6 is a block diagram of the communication between a Distributor 610 and Clearinghouse 640 once a new digital work is encoded and available on the web. Once a digital work is encoded and available on the web on a Distributor web site 610, the Meta-Data Reader module 630 (J) will collect meta-data regarding the new digital-work and alert it of the availability of the new digital work. The watermarker module 630 (C) on the Distributor's modular software application 630 will analyze the new digital work to determine the proper portions to insert the watermark and pass this information to the Meta-Data Reader Module. After collecting all the necessary meta-data a of the new digital work, the Meta-Data Reader Module will send communication 632 to the digital works Clearinghouse meta-data database 652 which will keep a record of the meta-data collected regarding the particular digital work in the Clearinghouse database 652. This will allow the Clearinghouse to house meta-data and digital works location information in one place and thereby enable the fulfillment of a consumer request by directing a Distributor looking for a particular digital work to another Distributor who has the digital work. In one embodiment, meta-data information is relayed by registering a directory accessed by the communication module. For example, by using Lightweight Directory Access Protocol (LDAP) whereby the communication module calls the Clearinghouse to register the digital work as soon as the digital work becomes available and the meta-data is captured. Alternatively, the server-to-server communication can be in the form of HTTP/SMTP mail message file transfer or via Java Message Service (JMS).

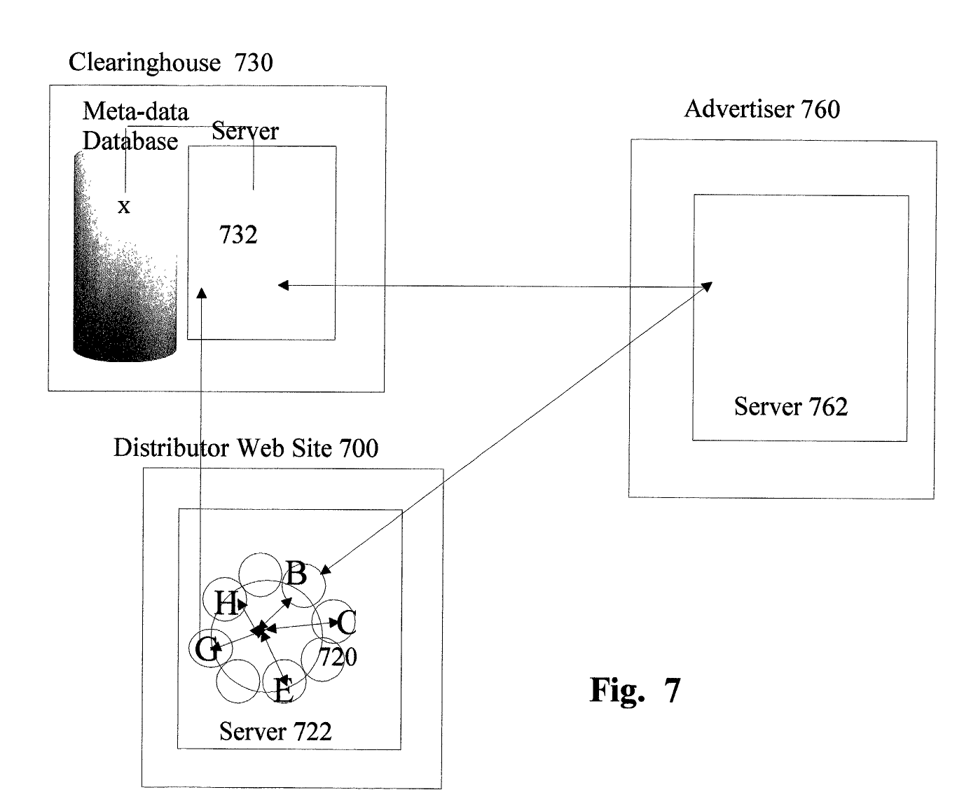

FIG. 7 is a block diagram of the communication between Advertiser 760, Clearinghouse 730 and Distributor 700. Distributor 760 will pass Clearinghouse 730 information regarding timing of music streaming, concert schedules and music shows or other streaming of data. Clearinghouse 730 will collect list of all advertising sites available on various Distributors so that Advertisers and Distributors can simultaneously purchase and sell advertisement time slots. Thus, the clearinghouse will enable advertisement time slot arbitrage. Advertiser 760 can engage in on-line bidding for various slots of time periods available by utilizing the list of advertising slots available on various Distributors or transact for a time slot at a standard rate. The advertiser 760 will link to Clearinghouse 730 to bid for the time slot. When Advertiser 760 has completed transacting with Distributor 700 regarding a particular time slot, Clearinghouse Server 732 will communicate with advertisement insertion module 720(H) of the downloaded modular application 720 to insert advertisement at the given time. The application will communicate with the streaming module (E) to coordinate insertion of an advertisement in between streams or downloads of a digital work prior to insertion of advertisement, the distribution-transfer module 720 (B) will connect with advertiser's server to transfer digital advertisement and store it in transfer module. The server-to-server communication can be in the form of HTTP/SMTP mail message file transfer or via Java Message Service (JMS).

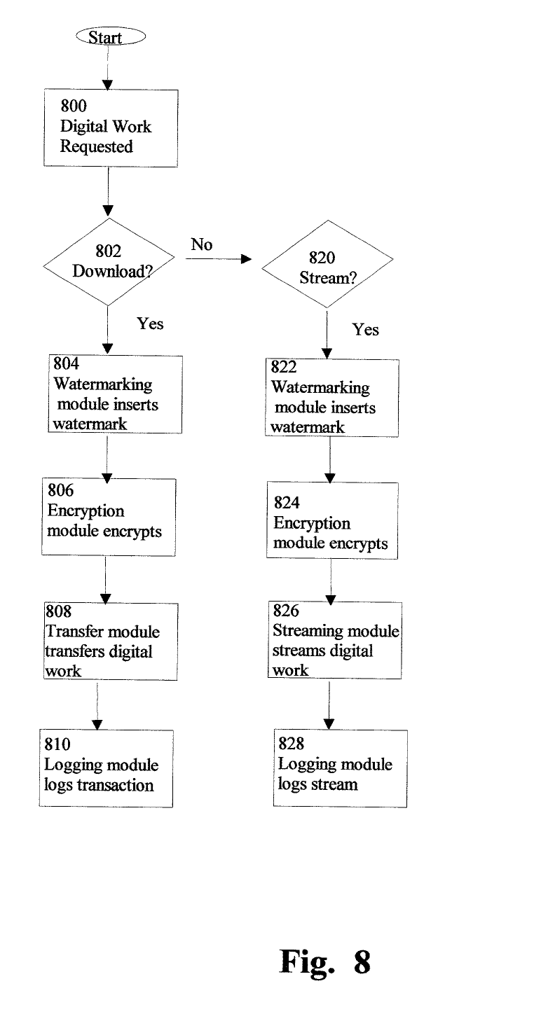

FIG. 8 is a flow chart depicting a process for watermarking, encrypting and transferring a digital work when it is requested. The process begins with step 800 when the Distributor's server is requested a particular digital work. In step 802, query whether the digital work will be downloaded or streamed? If the digital work is to be downloaded, the watermarking module of the modular application will insert a watermark identifying the particular association between consumer and Distributor. In step 806, the encryption module will encrypt the digital work. In step 808, the transfer module will transfer the digital work to the Distributor to further distribute to the customer or will directly distribute to the customer. In step 810, the logging module will log the transaction such that, the time of transaction, the identity of digital work and the customer information are recorded and stored. In this example embodiment the communication between the Distributor's server and the modules and the communication between the modules is accomplished using socket communication technology.

In step 820, query if digital work is to be streamed? In step 822, the watermarking module will insert watermarks in between blocks of stream of digital work. In step 824, the encryption module encrypts the digital work. In step 826, the streaming module will stream the digital work. In step 828, the logging module will log the time of stream, the location of the stream and other transaction information.

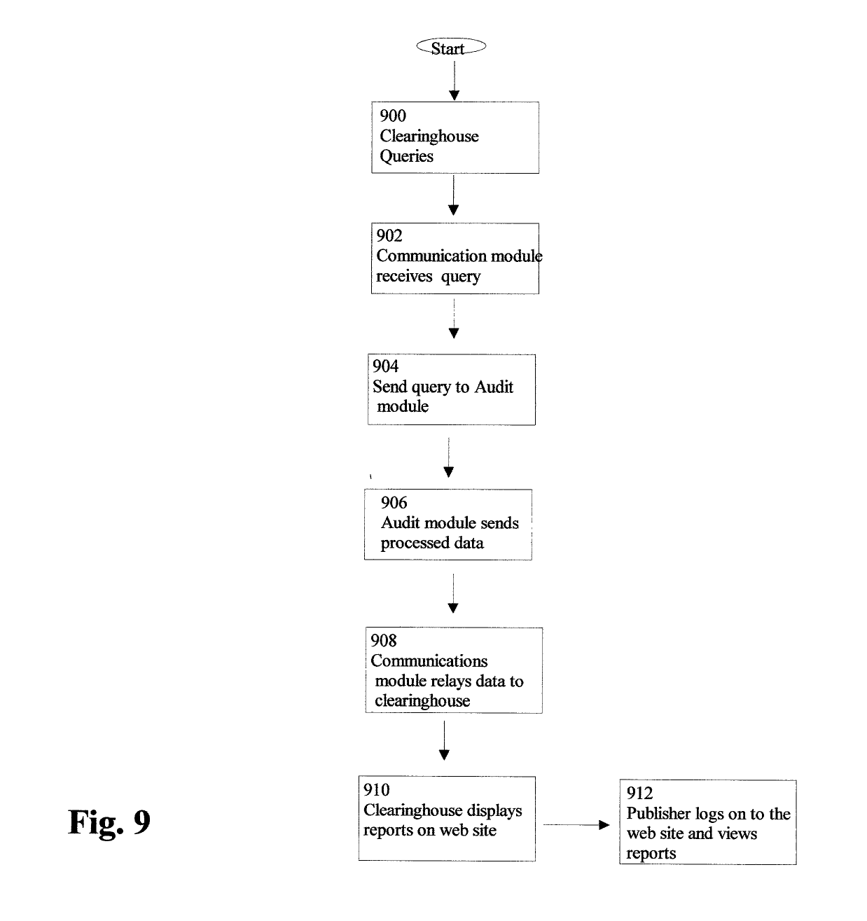

FIG. 9 is a flow chart depicting the communication between the Clearinghouse and Distributor to gather auditing and tracking information for Publisher. In step 900, Clearinghouse will query the communication module attached to a Distributor periodically. The communication may be in the form of a HTTP POST request to DWD. It may also utilize other mail and messaging protocols. For example, Clearinghouse may automatically query all the communication modules it is communicatively coupled to in California at 12:00 AM PST every day. Similarly, it may query all communications modules it is communicatively coupled to in Europe at 12:00 PM EST everyday. Periodically querying the modular application regarding the auditing information it has collected will ensure that Clearinghouse has updated information regarding how many downloads and streams were delivered every day. Also, varying the timings of queries depending on the geographic location of the Distributors will ensure load balancing so that the Clearinghouse is not burdened with communications from all modules it is communicatively coupled to. In another example embodiment, Clearinghouse may query the Distributor at a given time upon request by the Publisher regarding the status of a digital work. The query thus may also be initiated upon a particular request made by a Publisher or other authorized agency.

In step 902, the communication module of the Distributor's downloaded application receives query. The query may be in the form of a HTTP POST message or a messaging system such as JMS. In step 904, the communications module then hands off the request to auditing module. In step 906, the auditing module sends processed, concise data regarding the transactions of the day to communications module. The data may be transferred as a XML/HTML document or simply as a mail message using SMTP/HTTP protocol. In step 908, the communications module then sends audit data back to Clearinghouse. In step 910, Clearinghouse then collects all of the auditing information from various Distributors and organizes the data into reports according to the terms of the agreement it has reached with the Publisher. It then displays the auditing reports on a secure web site on its server. In step 912, the Publisher logs on to the web site using a login functionality and views auditing reports. The login functionality may require the Publisher to enter a identity and password. Alternatively, the auditing information that is collected and organized from various Distributors may also be sent as a message using messaging service or electronic mail service to DWPs or their information technology infrastructure.

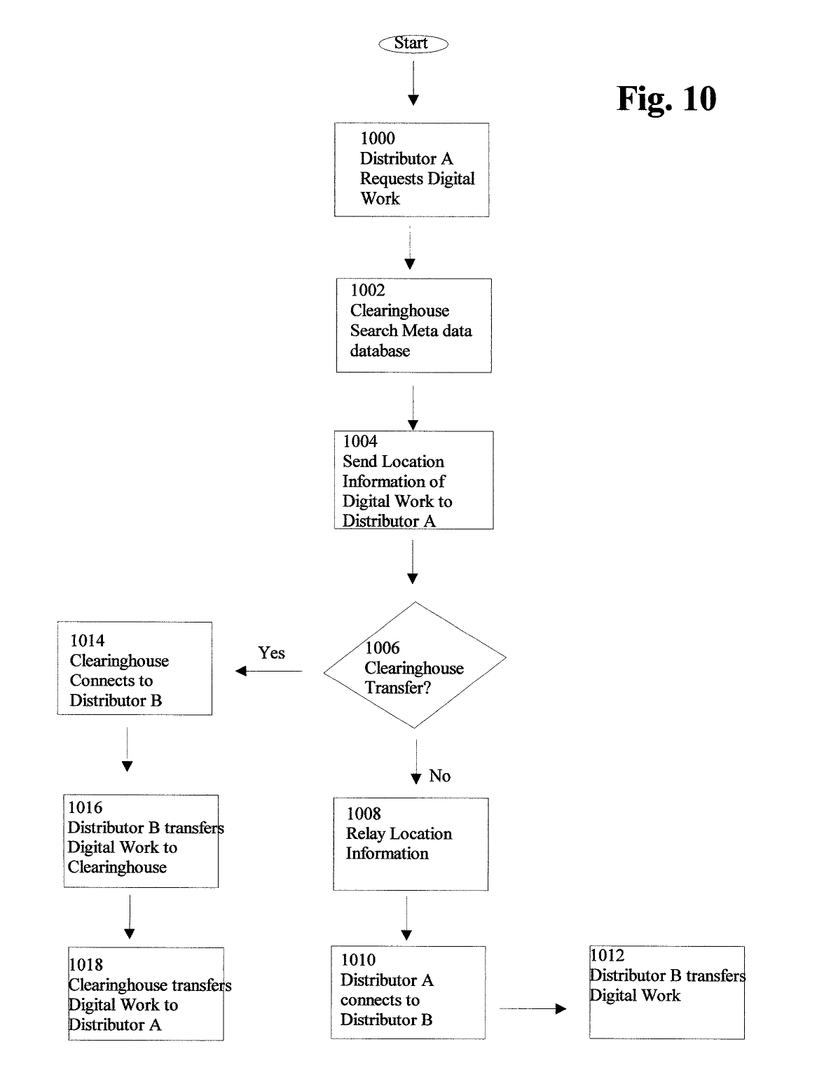

FIG. 10 is a flow chart depicting the transfer of a digital work from one Distributor to another through the Clearinghouse. In step 1000, Distributor A, upon realizing that a particular work is not available on their web server requests the Clearinghouse for the digital work. The request may be in the form of a HTTP POST message or a JMS. In step 1002, Clearinghouse searches its meta-data database to see where the digital work is present. In step 1004, Clearinghouse then relays the location information to Distributor A. The information may be relayed as an HTTP GET message or through utilizing JMS. In step 1006, Distributor A may either decide to have the Clearinghouse get the digital work from Distributor B or connect with Distributor B itself to get the digital work directly. If Distributor decides to get the digital work itself, in step 1008, Clearinghouse will relay digital work's location information to Distributor A. In step 1010, Distributor A will connect to Distributor B. In step 1012, Distributor B transfers the digital work to Distributor A. If Distributor A decides to have Clearinghouse get the digital work, Clearinghouse in step 1014 will connect to Distributor B. In step 1016, Distributor B transfers Digital Work to Clearinghouse. In step 1018, Clearinghouse transfers digital work to Distributor A.

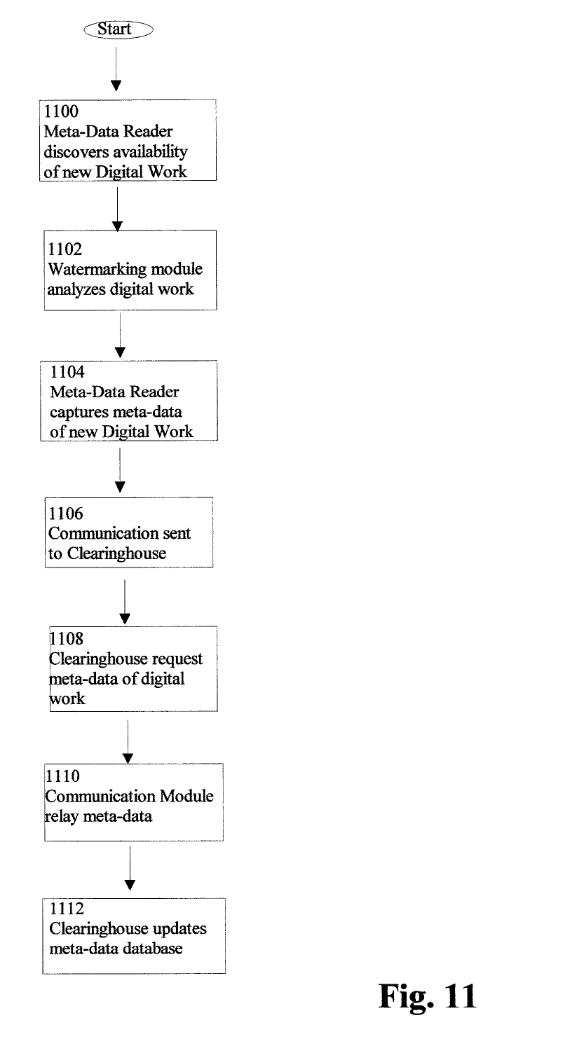

FIG. 11 is a flow chart depicting how Clearinghouse updates the meta-data database. In step 1100, Meta-Data Reader discovers availability of a new digital work. The watermarking module in step 1102 analyzes the digital work to determine where to insert watermarks. In step 1104, the Meta-Data Reader captures meta-data including the watermark analysis. In step 1106, application sends a communication to Clearinghouse regarding the availability of the digital work. In step 1108, Clearinghouse requests meta-data, including mathematical analysis of the proper portions to watermark the digital work. In step 1110, communications module relays the meta-data of a particular digital work to the Clearinghouse. The communication may be in the form of SMTP/HTTP or JMS. In step 1112, Clearinghouse updates meta-data database to include meta-data on the available digital work.

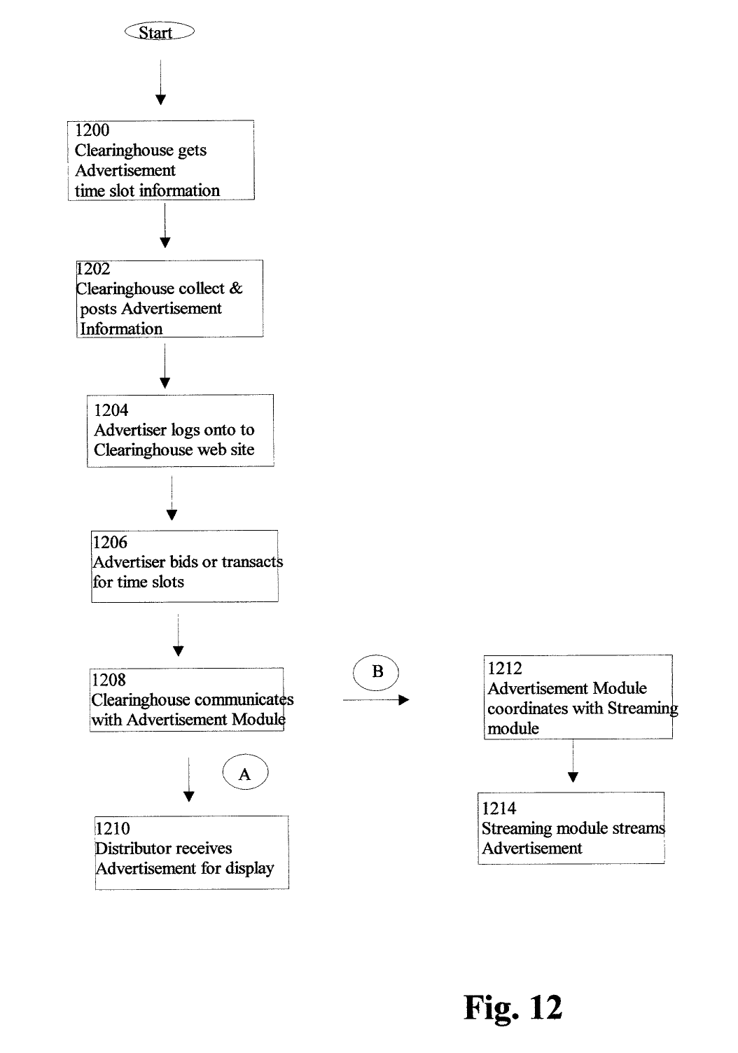

FIG. 12 is a flow chart depicting how Clearinghouse coordinates with advertiser and Distributor to insert advertisement during downloads or streams of a digital work. It begins with step 1200 where Clearinghouse gets information from various Distributors regarding availability of advertising time slots. In step 1202, Clearinghouse collects and posts advertisement information on a secure web page on its web site. In step 1204, advertiser logs onto the Clearinghouse web site to view the collected information. In step 1206, advertiser either bids for or transacts for the time slots with the Distributor using the information provided by the Clearinghouse website. In step 1208, the Clearinghouse then communicates with advertisement module to transfer advertisement. In step 1210, the Distributor accepts the transaction. In step 1212, Distributor receives advertisement for display. In step 1214, the advertisement is to be inserted while a digital work is streamed. For example, if a Madonna's concert was being streamed at a web caster's site, an advertiser may insert an advertisement in between songs, during breaks in the streaming of the digital work. In step 1216, the streaming module streams the advertisement.

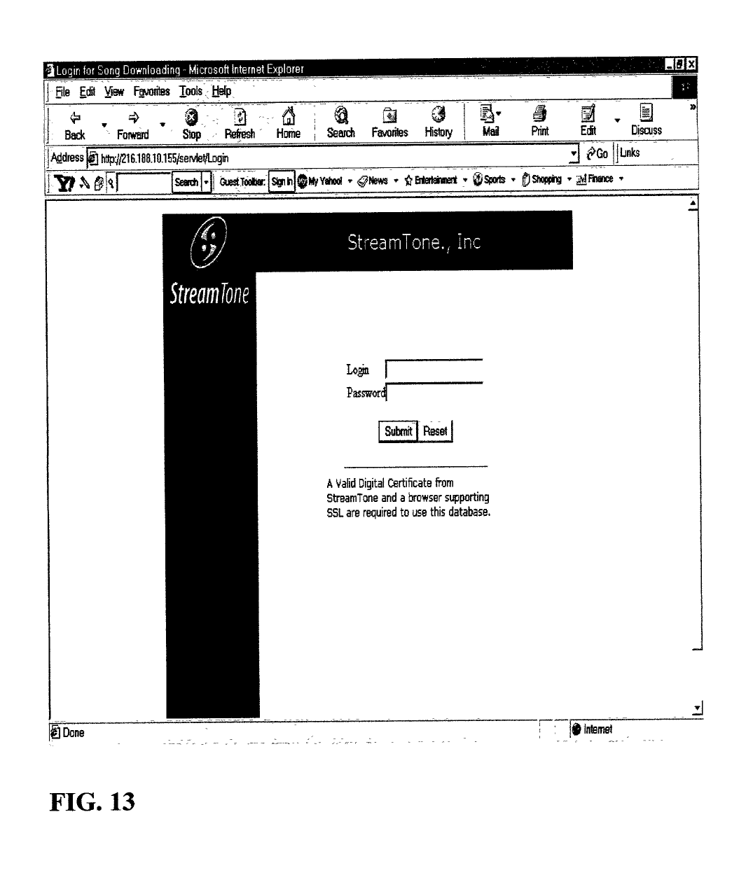

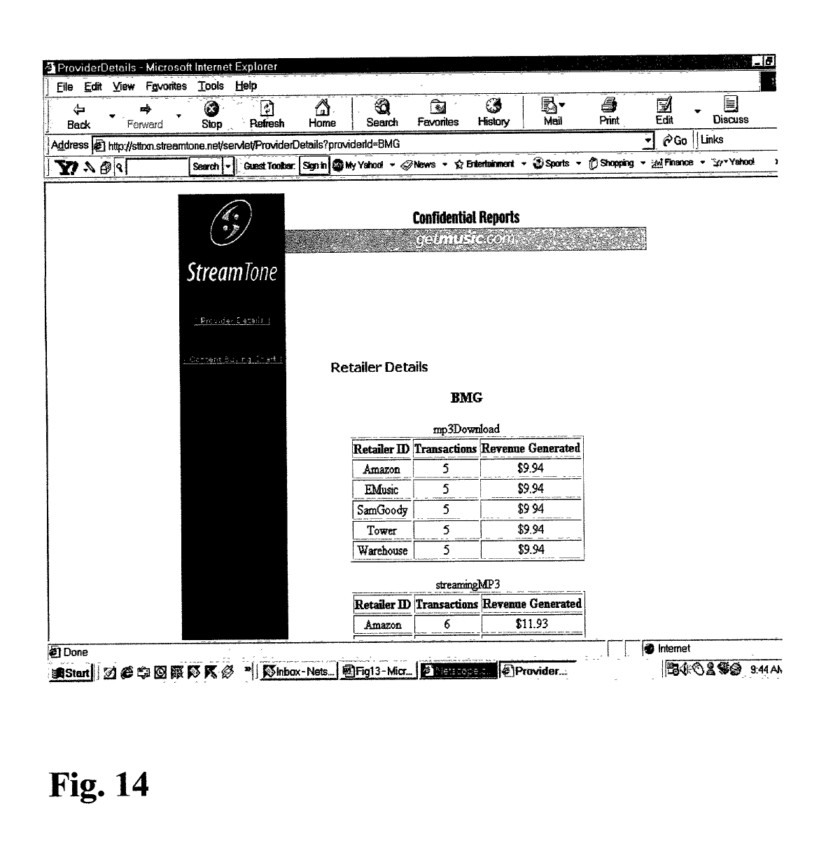

FIG. 13 is an example representation of the login functionality used by Publisher to login to Clearinghouse secure web site to view auditing reports. FIG. 14 is an example representation of the auditing reports viewable on an example web page on a secure site of the Clearinghouse.

The processes depicted in FIG.S 8, 9, 10, 11, 12 shows the general steps for fulfilling requests for digital works, collecting auditing information, relaying such information to a Publisher, relaying location information of a digital work to a Distributor who does not have a particular digital work, transferring the digital work, updating the digital work meta-data database and coordinating insertion of advertisements in between streams and downloads of a particular digital work. Because this process enables the creation of a digital works Clearinghouse Network for enabling the remote monitoring, auditing, tracking, transferring and streaming of a digital work, additional steps may be added to help ensure proper security and fail-safes are in place. For example, various parts of the system may crash from time to time. If the distributor's system goes down during a communication, this is identified by a timeout mechanism in the clearinghouse that follows up with the Distributor's communication module to check the extent to which the communication was carried out. Those skilled in the relevant art(s) will understand how to implement these additional steps to ensure proper security and fail-safes given the disclosure herein.

By creating a networking protocol that delineates the information that must be provided between DWDs and DWPs, the present invention eliminates the need for users to navigate to different Distributors to obtain a digital work and enables DWP's to obtain useful, accurate and instantaneous auditing, tracking data from a neutral third party. The present invention also provides a mechanism whereby the digital-works clearinghouse will house meta-data regarding the digital works available to facilitate the delivery of digital works and auditing functions of the digital works. The present invention also provides a mechanism whereby an Advertiser may coordinate with a Distributor to insert advertisement between streams and broadcasts of a digital work. In one embodiment, the parameters that go into the various communications described above are as follows:

Distributor Site Presents to Clearinghouse:

| | |
|---|---|
| Distributor Account Number | 012345678 (64 bits) |
| Distributor Digital Certificate | 0123456789abcdef (128 bits) |

| | |
|---|---|
| Audit Data: | |
| Number of total streams | 12334556 |
| Number of total downloads | 5678 |
| Number of total advertisements inserted | 97654 |
| Advertisement Detail Block Size | 10000 |
| Number of total ebooks downloaded | 123456 |
| Number of total movies downloaded | 67890 |
| Number of total software applications downloaded | 78954 |
| Number of audio books downloaded | 78980 |
| Number of electronic magazines downloaded | 4567 |
| Number of games downloaded | 234567 |
| Number audio/video/software services consumed | 123456 |

Publisher Presents to Clearinghouse:

| | |
|---|---|
| Publisher ID | UniversalMusicGroup |
| Password | brittanyspears123yx |
| Publisher Account Number | 012345678 (64 bits) |
| Publisher Digital Certificate | 0123456789abcdef (128 bits) |

Clearinghouse Presents Publisher:
Web Page with Auditing Reports, see FIG. 14

| | |
|---|---|
| Watermarking Application Module | |
| Input Parameters: | |
| InLocationPath | http://MusicStorage.distributor.net |
| Watermarking Meta Meta-Data | 1acd13bf6789edf656 |
| Transaction Tag | 17777678888888888 |
| ContentId | 123456789abcdef |
| Output Parameters: | |
| OutLocation | http://StreamArea.distributor.net |
| Transaction Tag | 17777678888888888 |

Encryption Application Module:
Input Parameters:
InLocation(The file location for input for unencrypted static content or
memory location for a stream buffer) http://StreamArea.distributor.net
Protocol (Encryption protocol to be used in the process) Rijandel
Key (The encryption key to be used for this transaction)
123456789abcdef123456789abcdef
TransactionTag (Unique transaction Id to reference the process to a
transaction)
17777678888888888
Output Parameters:
OutLocation(The file location for encrypted static content or memory
location for a stream buffer) http://StreamArea.distributor.net:8019?3600
TransactionTag (Unique transaction Id referencing the OutLocation
parameter)
17777678888888888
Security Application Module:
Input Parameters:
Request (OpenConnection, Digital Certificate, IDNumber, SecureMode)
Output Parameters:
Response(yes, no)
Stream:
Input parameters:
ContendId (Content Identifier)
ContentLocation (The file location for the content being streamed)
ClientID (The HTTP connection socket reference for Streamed Content)
TransactionTag (Unique transaction Id for this stream)
ContentIndex (index in the contentfile)
Status (Begin Stream, In Progress, Complete)
Output Parameters:
ContentIndexLocation(Location index in the contentfile)
StatusResponse (Began Stream, In Progress, Completed)
Logging Application Module:
Input Parameters:-

| | |
|---|---|
| Process | AdModule |
| Params | Distributor, Network, Time, Region |
| TimeStamp | 12:00AM PST |

Auditing Application Module:
Input Parameters:

| | |
|---|---|
| ServiceId or ContenttId | 899001225555 |
| TimePeriod | 12:36 PM |
| Geography | US |

Output Parameters:
UsageData:

| | |
|---|---|
| Number of total streams | 12334556 |
| Number of total downloads | 5678 |
| Number of total advertisements inserted | 97654 |
| Advertisement Detail Block Size | 10000 |
| Number of total ebooks downloaded | 123456 |
| Number of total movies downloaded | 67890 |
| Number of total software applications downloaded | 78954 |
| Number of audio books downloaded | 78980 |
| Number of electronic magazines downloaded | 4567 |
| Number of games downloaded | 234567 |
| Number audio/video/software services consumed | 123456 |

In addition, as mentioned previously, in one embodiment, all communications are implemented using SSL.

While various embodiments of the present invention have been described above, it should be understood that they have been presented by way of example only, and not limitation. It is to be understood that the description and drawings represent the presently preferred embodiment of the invention and are, as such, representative of the subject matter which is broadly contemplated by the present invention.

Furthermore, the scope of the present invention fully encompasses other embodiments that may become obvious to those skilled in the relevant art(s). For example, reference characters used to designate claim steps are provided for convenience of description only, and are not intended to imply any particular order for performing the steps. Thus, the breadth and scope of the present invention should not be limited by any of the above-described exemplary embodiments, but should be defined only in accordance with the following claims and their equivalents.

What is claimed is:

1. A method of enabling remote monitoring of digital rights, electronic sales and distribution, by Distributors of digital works owned by third party Publishers, the method comprising providing a digital-works Clearinghouse configured to communicate via a computer network and designed to coordinate collection of meta-data, distribution, monitor usage, track, provide auditing information and deliveries of digital works between Distributors, Publishers and end Consumers, the method further comprising a step of providing a software application to Distributor whereby a Publisher is enabled to remotely monitor transactional billing, and usage information along with protecting copyrights.

2. The method of claim 1, wherein the software application is hierarchically clustered and loosely coupled.

3. The method of claim 2, wherein the software application has at least one module or combination of modules.

4. The method of claim 3, wherein a module is a logging module.

5. The method of claim 3, wherein logging module logs all activity of digital works on distributor site.

6. The method of claim 3, wherein a module is a distribution module.

7. The method of claim 6, wherein the distribution module connects to other distributor's and clearinghouse to transmit digital-work.

8. The method of claim 3, wherein a module is a watermarking module.

9. The method of claim 8, wherein the watermarking module watermarks the digital work in real time before electronic transfer and/or distribution.

10. The method of claim 8, further comprising the step of providing a Distributor record-generation system for enabling Distributors to create a record that references the digital work.

11. The method of claim 3, wherein one module is an encrypting module.

12. The method of claim 3, wherein one module is a streaming module.

13. The method of claim 3, wherein one module is a communications module.

14. The method of claim 3, wherein one module is an advertisement insertion module.

15. The method of claim 14, further comprising the step of interacting with streaming module to insert advertisement in between streams.

16. The method of claim 3, wherein one module is an auditing module.

17. The method of claim 16, wherein the auditing module processes logged data into concise and organized format.

18. The method of claim 18, wherein the auditing information is communicated to Clearinghouse.

19. The method of claim 3, wherein one module is a meta-data reader module.

20. In a system for electronic distribution, distribution auditing of digital works via a computer network, a method of supporting electronic sales, distribution of digital works or licenses to use digital works, the method comprising:
Clearinghouse receiving a request for a digital work from a Distributor;
determining where the digital work is available;
passing meta information and encryption key to the Distributor;
Distributor connecting to the Distributor whose system has digital work or to the Clearinghouse;
transmission of digital work from one Distributor to another or Clearinghouse to Distributor; and
inserting a watermark that records the association between the Distributors or Distributor, Clearinghouse and Distributor.

21. The method of claim 20, wherein the determining step comprises checking a digital-works meta-data database for a record of the digital work.

22. A digital-works clearinghouse comprising:
a database, which stores meta-data relating to digital-works; and
a server configured to coordinate digital-works distribution, such that when a digital work request message is received, the server checks the meta-data database to determine where the digital work is available, passes meta information and encryption key of digital work to the distributor requesting the digital work so that the distributor will connect to the distributor and transmit digital work, and to relay auditing information it has collected from various distributors to the digital-works publisher.

23. A digital-works meta-data database that is automatically updated when a new digital work is available by a communication from the meta-data reader module residing on a remote distributor site that discovers and captures meta-data regarding new digital works available on that distributor's site.

23. The method claim 23 further comprising:
meta-data reader module discovering a new digital work when it becomes available on Distributor's site;
analyzing the new digital-work to determine the proper portions of the digital work to insert watermarks;
capturing meta-data including analysis of digital work available on Distributors site; and
communicating the meta-data captured to the digital-works Clearinghouse.

24. A method of enabling advertisement time-slot arbitrage between advertisers and distributors of digital works comprising:
generating list of available advertisement time slots;
displaying list for viewing by third-party advertisers;
communicating a request for inserting advertisement at a given time slot;
transacting for time slot;
accepting the transaction; and
inserting advertisement.

26.The method of claim 25, wherein the list generating system comprises;
communication by Distributors regarding available time slots;
compiling a list of all available time slots from all distributors; and
displaying list through clearinghouse.

27. The method of claim 25, wherein Advertiser delivers advertisement to distributor, software application inserts the advertisement.
